(19) United States
(12) Patent Application Publication
(10) Pub. No.: US 2025/0050730 A1
(43) Pub. Date: Feb. 13, 2025

(54) DRIVE UNIT

(71) Applicant: HONDA MOTOR CO., LTD., Tokyo (JP)

(72) Inventors: Takashi Wakui, Saitama (JP); Motoshi Togasaki, Saitama (JP); Masahiro Imai, Saitama (JP); Kazuki Sakurai, Saitama (JP)

(73) Assignee: HONDA MOTOR CO., LTD., Tokyo (JP)

(21) Appl. No.: 18/795,228

(22) Filed: Aug. 6, 2024

(30) Foreign Application Priority Data
Aug. 7, 2023 (JP) 2023-128835

(51) Int. Cl. B60K 17/16

(52) U.S. Cl. CPC B60K 17/16; B60Y 2400/73; B60Y 2410/10

(57) ABSTRACT

A drive unit includes a drive motor, a speed reducer which outputs power of the drive motor at a reduced speed, and a drive unit case which accommodates the drive motor and the speed reducer. An output rotary shaft of the drive motor and an output rotary shaft of the speed reducer are arranged in parallel and aligned in a horizontal direction. The drive unit case has a motor chamber in which the drive motor is accommodated, and a gear chamber provided with an accommodating chamber in which the speed reducer is accommodated. The motor chamber and the gear chamber are divided by a dividing wall. An upper space and a lower space separated in an upper-lower direction by an upper-lower dividing wall extending from the dividing wall are formed between the motor chamber and the accommodating chamber.

### CROSS-REFERENCE TO RELATED APPLICATIONS

This application is based on and claims priority under 35 USC 119 from Japanese Patent Application No. 2023-128835 filed on Aug. 7, 2023, the entire content of which is incorporated herein by reference.

### TECHNICAL FIELD

The present disclosure relates to a drive unit to be mounted on an electric vehicle or the like.

### BACKGROUND ART

In recent years, efforts to realize a low carbon social or a decarburized social have been activated, and research and development have been performed on an electrification technique in order to reduce CO₂ emissions and improve energy efficiency even in vehicles.

In an electrification technique for vehicles, to have higher degree of freedom for mounting to a vehicle, a drive unit is required to be downsized, and is particularly required to be reduced in size in the height direction. In addition, to improve the electricity consumption and the cruising distance, a drive unit is required to transmit power efficiently.

For example, JP2004-180477A describes a drive unit that improves the lubricating performance by forming a space for storing lubrication oil in a drive unit case.

However, in the drive unit disclosed in JP2004-180477A, the space for storing the lubrication oil is formed above a drive gear provided on a main shaft of a speed reducer. This increases the dimension in the upper-lower direction of the drive unit.

### SUMMARY OF INVENTION

The present disclosure provides a drive unit capable of forming a space in a drive unit case while limiting an increase in upper-lower dimension.

An aspect of the present disclosure relates to a drive unit including:
a drive motor;
a speed reducer configured to output power of the drive motor at a reduced speed; and
a drive unit case configured to accommodate the drive motor and the speed reducer,
in which an output rotary shaft of the drive motor and an output rotary shaft of the speed reducer are arranged in parallel and aligned in a horizontal direction,
the drive unit case has:
   a motor chamber in which the drive motor is accommodated; and
   a gear chamber provided with an accommodating chamber in which the speed reducer is accommodated,
the motor chamber and the gear chamber are divided by a dividing wall, and
an upper space and a lower space separated in an upper-lower direction by an upper-lower dividing wall extending from the dividing wall are formed between the motor chamber and the accommodating chamber.

According to the present disclosure, the upper space and the lower space can be formed in the drive unit case while limiting an increase in the upper-lower dimension.

### BRIEF DESCRIPTION OF DRAWINGS

Exemplary embodiment(s) of the present invention will be described in detail based on the following figures, wherein:

FIG. 1 is a schematic view of a vehicle mounted with a drive unit according to an embodiment of the present disclosure, as viewed from the left;

FIG. 2 is a perspective view of the drive unit according to the embodiment of the present disclosure, with a part thereof cut out;

FIG. 3 is a partial perspective cross-sectional view illustrating a power transmission path in the drive unit in FIG. 2;

FIG. 4 is a skeleton diagram of a speed reducer in the drive unit in FIG. 2;

FIG. 5 is a top view and a left side view of the drive unit in FIG. 2;

FIG. 6 is a perspective view of a left main case of the drive unit in FIG. 2 as viewed from the left;

FIG. 7 is a cross-sectional view taken along a line A-A in FIG. 5;

FIG. 8 is a perspective view of the left main case of the drive unit in FIG. 2 as viewed from the right;

FIG. 9 is a perspective view of a right main case of the drive unit in FIG. 2 as viewed from the left;

FIG. 10 is a cross-sectional view taken along a line B-B in FIG. 5;

FIG. 11 is a block diagram of a temperature control system in the drive unit in FIG. 2;

FIG. 12 is a perspective view of the drive unit in FIG. 2, with a part thereof cut out in the left-right direction;

FIG. 13 is a cross-sectional view of the drive unit illustrated in FIG. 2, which is cut in the left-right direction along the axes of a left drive shaft and a right drive shaft;

FIG. 14 is a perspective view of a left side cover and a baffle plate of the drive unit in FIG. 2;

FIG. 15 is a perspective view of a part of the drive unit in FIG. 2, with a part thereof cut out in the front-rear direction;

FIG. 16 is a cross-sectional view of the main part of a gear chamber, with a part of the drive unit in FIG. 2 cut out in the front-rear direction;

FIG. 17 is a perspective view of the main part of the gear chamber, when the drive unit in FIG. 2 is viewed with the right main case removed;

FIG. 18 is a perspective view of the drive unit in FIG. 2, with a part thereof cut out in the left-right direction and the right main case removed;

FIG. 19 is a perspective view of a part of the drive unit in FIG. 2, which is cut in the left-right direction;

FIG. 20 is a perspective view of a right main case of the drive unit in FIG. 2; and

FIG. 21 is a perspective view of the drive unit in FIG. 2, with a part of the right main case and the right side cover cut out in the left-right direction.

### DESCRIPTION OF EMBODIMENTS

Hereinafter, a vehicle on which a drive unit that is an embodiment of a power transmission device of the present disclosure is mounted will be described with reference to the accompanying drawings. The drawings are viewed in the directions of reference signs. In the present specification and the like, in order to simplify and clarify the description, the front-rear, left-right, and upper-lower directions are described according to directions viewed from the driver of the vehicle. In the drawings, the front side of the vehicle is shown as Fr, the rear side as Rr, the left side as L, the right side as R, the upper side as U, and the lower side as D.

### Overall Configuration of Vehicle

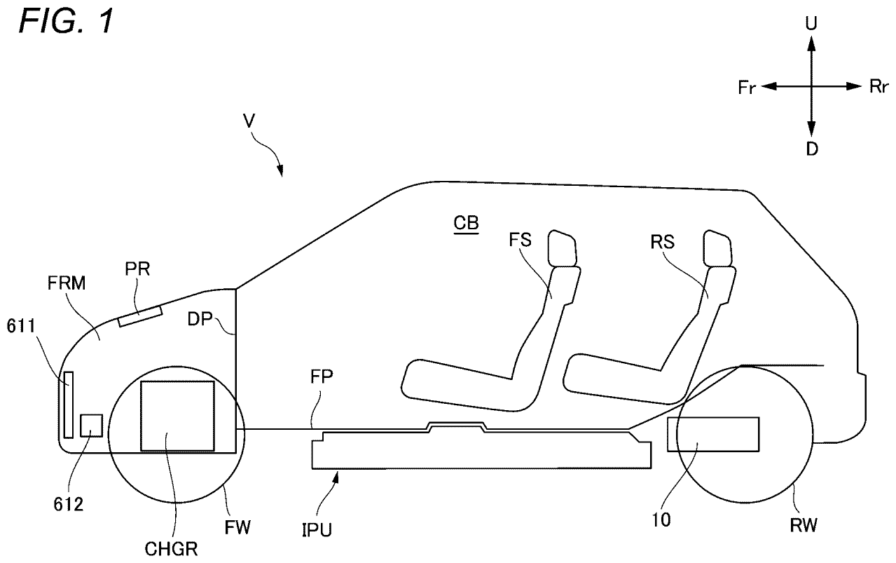

As illustrated in FIG. 1, a vehicle V according to the present embodiment includes a pair of left and right front wheels FW, a pair of left and right rear wheels RW, and a floor panel FP constituting the floor of the vehicle V. The vehicle V is divided, by a dash panel DP extending in the upper-lower direction above the floor panel FP, into a passenger compartment CB and a front room FRM in front of the passenger compartment CB. The passenger compartment CB is provided with front seats FS and rear seats RS.

The vehicle V includes a drive unit 10 serving as a drive source, a battery pack IPU for storing the electric power to be supplied to the drive unit 10, a charge and power supply control device CHGR for controlling the input and output power of the battery pack IPU, a power-receiving portion PR capable of receiving power from an external power supply, a radiator 611 that allows cooling water RI for cooling a control device 50 to be described later of the drive unit 10 to flow, and a cooling water pump 612 for pressure-feeding the cooling water R1. The cooling water RI is, for example, cooling water called LLC (long life coolant).

The drive unit 10 is disposed behind the rear seats RS and below the floor panel FP. The battery pack IPU is disposed below the floor panel FP and below the floor of the passenger compartment CB. The battery pack IPU accommodates a plurality of battery modules in which a plurality of battery cells are stacked. Each battery cell is a rechargeable secondary battery such as a lithium-ion battery or an all-solid-state battery.

The charge and power supply control device CHGR is accommodated in the front room FRM. The power-receiving portion PR is provided on the upper surface of the front room FRM and is electrically connected to the charge and power supply control device CHGR. The radiator 611 is accommodated in the front room FRM, and is disposed in the vicinity of the front end in the front room FRM. The radiator 611 is a heat exchanger for cooling the cooling water R1 by heat exchange between the flowing cooling water R1 and external air due to the traveling wind of the vehicle V. The cooling water pump 612 is accommodated in the front room FRM.

### Overall Configuration of Drive Unit

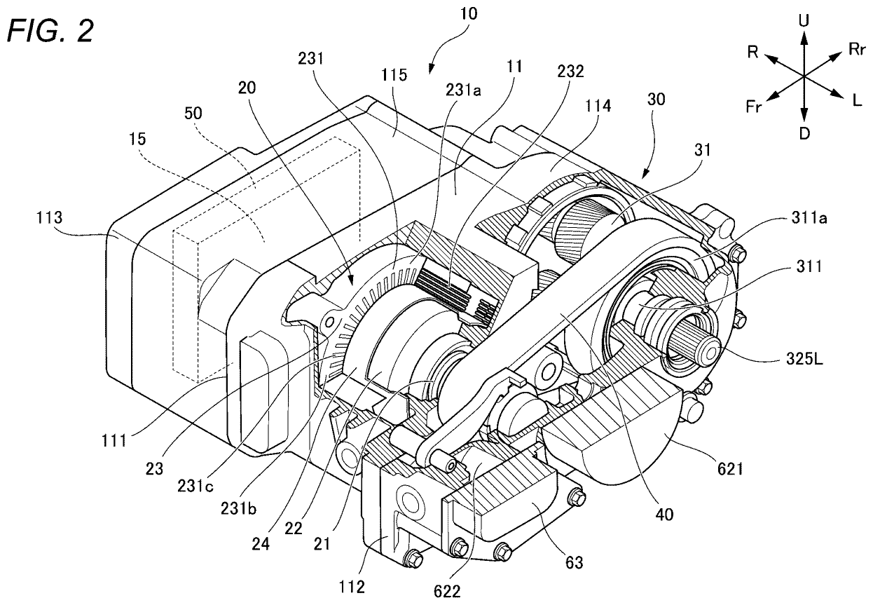

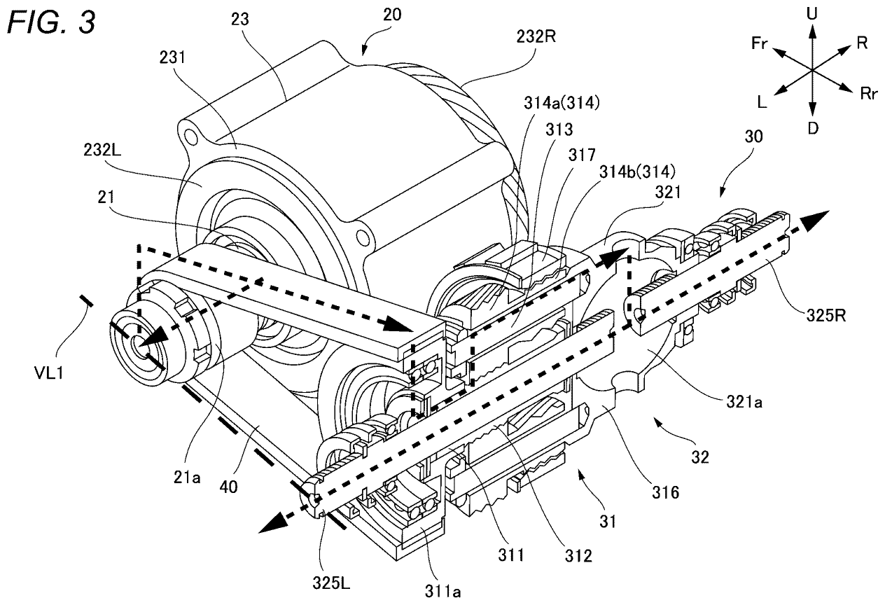

As illustrated in FIGS. 2 and 3, the drive unit 10 includes a drive motor 20, a speed reducer 30 for outputting the power output from the drive motor 20 to the outside at a reduced speed, a power transmission chain 40 for transmitting the power output from the drive motor 20 to the speed reducer 30, a control device 50 for controlling the drive motor 20, an oil pump 621 for pressure-feeding the motor cooling oil R2, and an oil cooler 63 for performing heat exchange between the cooling water R1 and the motor cooling oil R2. The motor cooling oil R2 is, for example, oil called ATF (automatic transmission fluid).

In the drive unit 10, the drive motor 20, the speed reducer 30, the power transmission chain 40, and the control device 50 are accommodated in the drive unit case 11. The oil pump 621 and the oil cooler 63 are attached to the left side surface of the drive unit case 11.

The drive motor 20 is a so-called inner rotor motor including a drive shaft 21, a rotor 22 that is attached to the drive shaft 21 and rotates integrally with the drive shaft 21, and a stator 23 that faces the rotor 22 in the radial direction with a slight gap on the radially outer side of the rotor 22.

In the present embodiment, in the drive unit 10, the drive motor 20 is arranged such that the axial direction thereof (that is, the drive shaft 21) is oriented horizontally in the left-right direction. In this way, since the drive shaft 21 is oriented in the horizontal direction, the upper-lower dimension of the drive unit 10 can be made compact.

The stator 23 includes a stator core 231, and a coil 232 attached to the stator core 231 and configured with a plurality of winding wires of a U phase, a V phase, and a W phase.

The stator core 231 is formed by laminating, in the axial direction, a plurality of thin plate-shaped magnetic steel plates having a substantially annular shape.

The stator core 231 includes a yoke 231a having a substantially annular shape that forms an outer ring of the stator core 231 as viewed in the axial direction, and a plurality of teeth 231b that protrude in the radial direction from the inner peripheral surface of the yoke 231a toward the center. The teeth 231b are arranged at equal intervals along the circumferential direction of the stator core 231 as viewed in the axial direction. A slot 231c is formed between the teeth 231b adjacent in the circumferential direction of the stator core 231. A plurality of slots 231c are formed at equal intervals along the circumferential direction of the stator core 231. The teeth 231b and the slots 231c extend along the axial direction of the stator core 231.

The coil 232 is configured with a plurality of conductor segments inserted into the slots 231c of the stator core 231. The conductor segments are inserted into all the slots 231c formed along the circumferential direction of the stator core 231.

The coil 232 includes a left coil end 232L that protrudes axially outward from the left end surface on one side in the axial direction of the stator core 231, and a right coil end 232R that protrudes axially outward from the right end surface on the other side in the axial direction of the stator core 231.

The left end of the drive shaft 21 is attached with a drive sprocket 21a wound around by the power transmission chain 40. The drive sprocket 21a rotates integrally with the drive shaft 21.

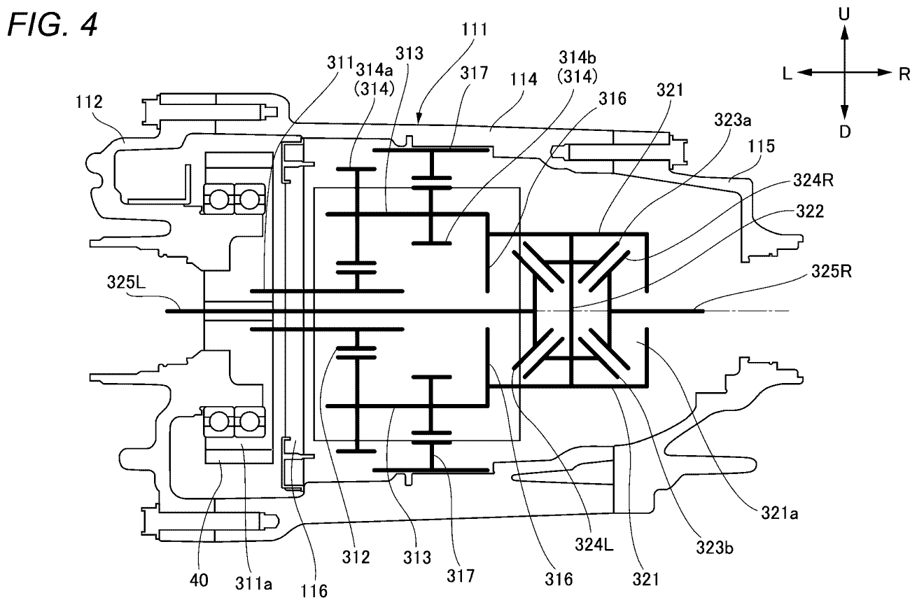

As illustrated in FIGS. 3 and 4, the speed reducer 30 includes a planetary gear mechanism 31 and a differential gear mechanism 32.

First, the planetary gear mechanism 31 will be described.

The planetary gear mechanism 31 includes an input shaft 311, a sun gear 312, a plurality of planetary pinion shafts 313, stepped pinions 314 of the same number as the planetary pinion shafts 313, a planetary carrier 316, and a ring gear 317.

In the present embodiment, the planetary gear mechanism 31 is aligned on the rear with drive motor 20 in the front-rear direction. The planetary gear mechanism 31 is arranged such that the axial direction thereof (that is, the input shaft 311) is oriented in the left-right direction parallel to the axial direction of the drive motor 20. The input shaft 311 of the planetary gear mechanism 31 is arranged at substantially the same height in the upper-lower direction as the drive shaft 21 of the drive motor 20. The outer diameter dimension of the planetary gear mechanism 31 is substantially the same as the outer diameter dimension of the drive motor 20, and the height in the upper-lower direction of the drive unit 10 is reduced.

The input shaft 311 is a hollow shaft, and has a left drive shaft to be described later inserted therein. The left end of the input shaft 311 is attached with a driven sprocket 311a wound around by the power transmission chain 40. The driven sprocket 311a rotates integrally with the input shaft 311. The driven sprocket 311a has a larger diameter than the drive sprocket 21a attached to the drive shaft 21 of the drive motor 20, and the number of teeth of the driven sprocket 311a is greater than the number of teeth of the drive sprocket 21a.

The sun gear 312 is an external gear provided on the input shaft 311 and rotates integrally with the input shaft 311 on the same rotary shaft.

The plurality of planetary pinion shafts 313 are arranged at equal intervals in the circumferential direction along the outer peripheral surface of the sun gear 312 while being oriented in the left-right direction in parallel with the input shaft 311 on the radially outer side of the sun gear 312. In the present embodiment, four planetary pinion shafts 313 are arranged on the radially outer side of the sun gear 312 at intervals of 90 degrees in the circumferential direction along the circumferential direction of the input shaft 311.

Each planetary pinion shaft 313 rotatably supports a stepped pinion 314 having a first planetary gear 314a and a second planetary gear 314b that rotate integrally. In the present embodiment, in each planetary pinion shaft 313, the first planetary gear 314a is arranged on the left and the second planetary gear 314b is arranged on the right. Therefore, four first planetary gears 314a and four second planetary gears 314b are provided in an annular shape at intervals of 90 degrees in the circumferential direction of the input shaft 311.

The first planetary gear 314a is an external gear arranged on the outer peripheral surface of the sun gear 312 and meshing with the sun gear 312. The four first planetary gears 314a are provided in an annular shape at intervals of 90 degrees along the outer peripheral surface of the sun gear 312. The four first planetary gears 314a mesh with the outer peripheral surface of the sun gear 312.

The second planetary gear 314b is an external gear arranged on the inner peripheral surface of the ring gear 317 and meshing with the ring gear 317. The four second planetary gears 314b are provided in an annular shape at intervals of 90 degrees along the inner peripheral surface of the ring gear 317. In the present embodiment, the second planetary gear 314b is an external gear having a smaller diameter than the first planetary gear 314a.

The planetary carrier 316 couples the four planetary pinion shafts 313. The planetary carrier 316 can rotate integrally with the four planetary pinion shafts 313 around a rotary shaft coaxial with the input shaft 311 (and the sun gear 312).

Therefore, the stepped pinion 314 having the first planetary gear 314a and the second planetary gear 314b can rotate around the planetary pinion shaft 313, and can revolve around a rotary shaft coaxial with the input shaft 311 (and the sun gear 312) integrally with the planetary pinion shaft 313. The planetary carrier 316 rotates integrally with the revolution of the stepped pinion 314 around a rotary shaft coaxial with the input shaft 311 (and the sun gear 312).

The ring gear 317 is an internal gear having an annular shape arranged surrounding the four second planetary gears 314b arranged in an annular shape, and the inner peripheral surface thereof meshes with the second planetary gears 314b. In the present embodiment, the ring gear 317 is fixed to the drive unit case 11, and the ring gear 317 itself does not rotate.

Next, the differential gear mechanism 32 will be described.

The differential gear mechanism 32 includes a differential case 321, a differential pinion shaft 322 supported by the differential case 321, a first bevel gear 323a and a second bevel gear 323b that are rotatably supported by the differential pinion shaft 322, a left side gear 324L and a right side gear 324R that mesh with the first bevel gear 323a and the second bevel gear 323b, and a left drive shaft 325L and a right drive shaft 325R.

The differential case 321 is formed integrally with the planetary carrier 316 of the planetary gear mechanism 31. Therefore, the differential case 321 rotates integrally with the planetary carrier 316 of the planetary gear mechanism 31 around a rotary shaft coaxial with the input shaft 311. The differential case 321 includes an accommodating portion 321a that accommodates the differential pinion shaft 322, the first bevel gear 323a, the second bevel gear 323b, the left side gear 324L, and the right side gear 324R.

The differential pinion shaft 322 is accommodated in the accommodating portion 321a of the differential case 321 and is supported by the differential case 321. The differential pinion shaft 322 is arranged in the accommodating portion 321a of the differential case 321 in a manner orthogonal to the rotary shaft of the differential case 321. The differential pinion shaft 322 rotates integrally with the differential case 321 around the rotary shaft of the differential case 321.

The first bevel gear 323a is accommodated in the accommodating portion 321a of the differential case 321 and is rotatably supported by the differential pinion shaft 322. The first bevel gear 323a has a substantially truncated conical shape whose upper surface is oriented toward the rotary shaft of the differential case 321, and has a gear formed on the truncated conical side surface.

The second bevel gear 323b is accommodated in the accommodating portion 321a of the differential case 321 and is rotatably supported by the differential pinion shaft 322 while facing the first bevel gear 323a. The second bevel gear 323b has a substantially truncated conical shape whose upper surface is oriented toward the rotary shaft of the differential case 321, and has a gear formed on the truncated conical side surface.

The left side gear 324L is accommodated in the accommodating portion 321a of the differential case 321, and is arranged to the left of the differential pinion shaft 322 and between the first bevel gear 323a and the second bevel gear 323b. The rotary shaft of the left side gear 324L is coaxial with the rotary shaft of the differential case 321. The left side gear 324L has a substantially truncated conical shape whose upper surface is oriented toward the differential pinion shaft 322 (that is, rightward), and has a gear formed on the truncated conical side surface. The left side gear 324L meshes with both the first bevel gear 323a and the second bevel gear 323b.

The right side gear 324R is accommodated in the accommodating portion 321a of the differential case 321, and is arranged to the right of the differential pinion shaft 322 and between the first bevel gear 323a and the second bevel gear 323b, in a manner facing the left side gear 324L in the left-right direction with the differential pinion shaft 322 interposed therebetween. The rotary shaft of the right side gear 324R is coaxial with the rotary shaft of the differential case 321 and the rotary shaft of the left side gear 324L. The right side gear 324R has a substantially truncated conical shape whose upper surface is oriented toward the differential pinion shaft 322 (that is, leftward), and has a gear formed on the truncated conical side surface. The right side gear 324R meshes with both the first bevel gear 323a and the second bevel gear 323b.

The left drive shaft 325L is inserted through the hollow portion of the input shaft 311 of the planetary gear mechanism 31 and the center of the driven sprocket 311a, and extends in the left-right direction coaxially with the rotary shaft of the input shaft 311 of the planetary gear mechanism 31 and the rotary shaft of the differential case 321. The left drive shaft 325L has the left side gear 324L attached to the right end thereof and the left rear wheel RW attached to the left end thereof. Therefore, the left side gear 324L, the left drive shaft 325L, and the left rear wheel RW rotate integrally.

The right drive shaft 325R extends in the left-right direction coaxially with the rotary shaft of the input shaft 311 of the planetary gear mechanism 31, the rotary shaft of the differential case 321, and the rotary shaft of the left drive shaft 325L. The right drive shaft 325R has the right side gear 324R attached to the left end thereof and the right rear wheel RW attached to the right end thereof. Therefore, the right side gear 324R, the right drive shaft 325R, and the right rear wheel RW rotate integrally.

Thus, since the differential case 321 is formed integrally with the planetary carrier 316 of the planetary gear mechanism 31, the planetary gear mechanism 31 and the differential gear mechanism 32 can be integrated. This can further downsize the speed reducer 30.

Next, the power transmission path of the power output from the drive motor 20 will be described.

The power generated by the drive motor 20 is output from the drive shaft 21. The drive sprocket 21a attached to the drive shaft 21 rotates integrally with the drive shaft 21. When the drive sprocket 21a rotates, the driven sprocket 311a is rotated by the power transmission chain 40 wound around the drive sprocket 21a and the driven sprocket 311a attached to the input shaft 311 of the planetary gear mechanism 31. The input shaft 311 of the planetary gear mechanism 31 rotates integrally with the driven sprocket 311a. At this time, since the number of teeth of the driven sprocket 311a is larger than the number of teeth of the drive sprocket 21a, the rotation of the drive shaft 21 is input to the input shaft 311 of the planetary gear mechanism 31 at a speed reduced through the drive sprocket 21a, the power transmission chain 40, and the driven sprocket 311a.

In the planetary gear mechanism 31, the power input to the input shaft 311 is transmitted to the stepped pinion 314 via the sun gear 312. Then, the stepped pinion 314 rotates and revolves. The planetary carrier 316 rotates integrally with the revolution of the stepped pinion 314. In the planetary gear mechanism 31, since the ring gear 317 is fixed, the rotation of the input shaft 311 is transmitted to the planetary carrier 316 at a speed reduced at a predetermined speed reduction ratio.

In the differential gear mechanism 32, the differential case 321 is formed integrally with the planetary carrier 316 of the planetary gear mechanism 31, and thus rotates integrally with the rotation of the planetary carrier 316. Therefore, the power input to the input shaft 311 of the planetary gear mechanism 31 is decelerated at a predetermined speed reduction ratio and input to the differential case 321 via the planetary carrier 316.

Therefore, the power output from the drive shaft 21 is input to the differential case 321 of the differential gear mechanism 32 via the power transmission chain 40 and the planetary gear mechanism 31, and the differential pinion shaft 322 revolves around the rotary shaft of the differential case 321 together with the differential case 321.

When the vehicle V travels straight, there is no rotation difference between the left and right rear wheels RW, and thus the left side gear 324L and the right side gear 324R that mesh with the first bevel gear 323a and the second bevel gear 323b rotate according to the rotation of the differential pinion shaft 322. The left rear wheel RW rotates when the left drive shaft 325L rotates integrally with the rotation of the left side gear 324L, and the right rear wheel RW rotates when the right drive shaft 325R rotates integrally with the rotation of the right side gear 324R.

When the vehicle V turns, as the differential pinion shaft 322 revolves, the first bevel gear 323a and the second bevel gear 323b rotate such that the rotation speed of the rear wheel RW on the inner side during turning decreases whereas the rotation speed of the rear wheel RW on the outer side during turning increases. Meanwhile, the left side gear 324L and the right side gear 324R that mesh with the first bevel gear 323a and the second bevel gear 323b, rotate at different rotation speeds such that the rotation speed of the rear wheel RW on the inner side during turning decreases whereas the rotation speed of the rear wheel RW on the outer side during turning increases. The left rear wheel RW rotates when the left drive shaft 325L rotates integrally with the rotation of the left side gear 324L, and the right rear wheel RW rotates when the right drive shaft 325R rotates integrally with the rotation of the right side gear 324R. Therefore, when the vehicle V turns, the left drive shaft 325L and the right drive shaft 325R rotate such that the rotation speed of the rear wheel RW on the inner side during turning decreases whereas the rotation speed of the rear wheel RW on the outer side during turning increases.

In this manner, as indicated by the arrows in FIG. 3, the power output from the

drive motor 20 is input to the speed reducer 30 at a speed reduced through the drive sprocket 21a, the driven sprocket 311a, and the power transmission chain 40. The power is appropriately distributed and transmitted to the left and right rear wheels RW by the differential gear mechanism 32 at a speed further reduced by the planetary gear mechanism 31.

By using the planetary gear mechanism 31 in the speed reduction mechanism, it is possible to obtain a desired speed reduction ratio while limiting an increase in dimension in the radial direction relative to the rotary shaft direction.

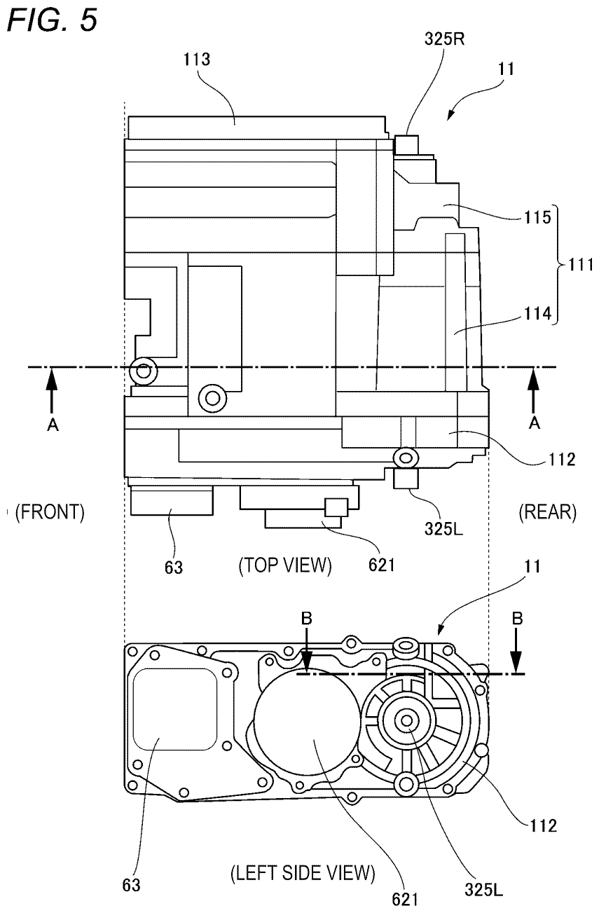

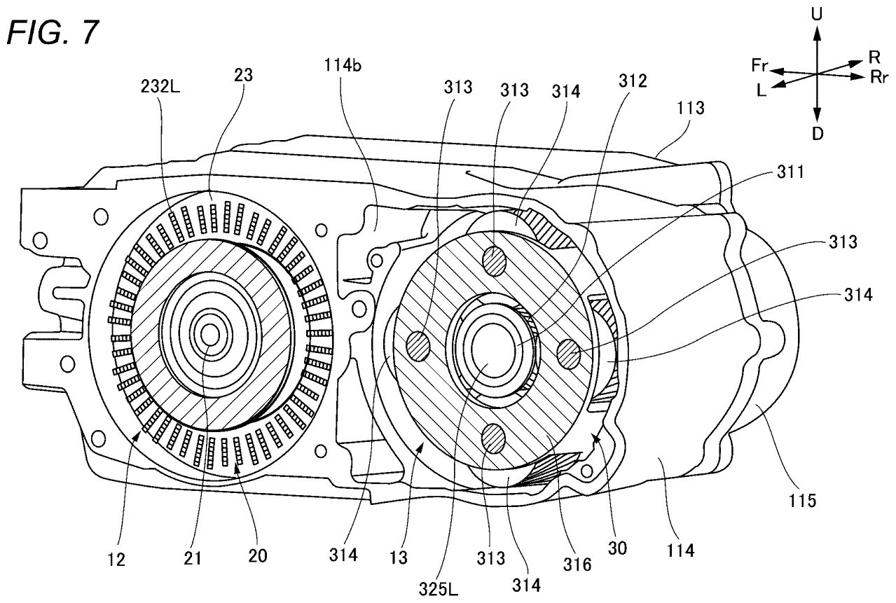

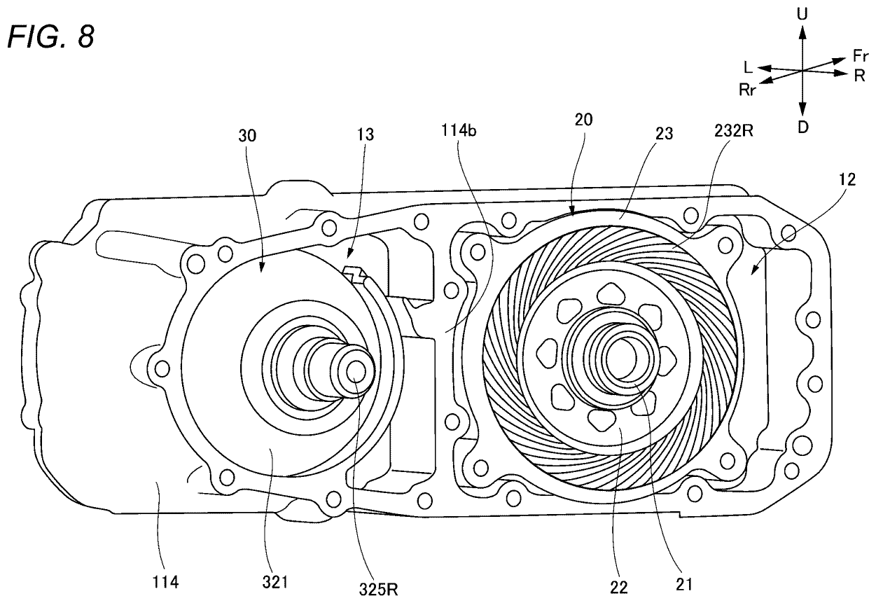

Next, the drive unit case 11 will be described with reference to FIGS. 5 to 10.

The drive unit case 11 includes a main case 111, a left side cover 112 covering the left side surface of the main case 111, and a right side cover 113 covering the right side surface of the main case 111. The main case 111 is divided into right and left portions, that is, a left main case 114 and a right main case 115.

The main case 111 is divided into a motor chamber 12 in which the drive motor 20 accommodated, a gear chamber 13 in which the speed reducer 30 is accommodated, a chain chamber 14 in which the power transmission chain 40 is accommodated, and a controller chamber 15 in which the control device 50 is accommodated. The motor chamber 12 and the gear chamber 13 are formed side by side in the front-rear direction such that the motor chamber 12 is located on the front side and the gear chamber 13 is located on the rear side. The chain chamber 14 is formed to the left of the motor chamber 12 and the gear chamber 13, and is open leftward. The controller chamber 15 is formed to the right of the motor chamber 12 and the gear chamber 13, and is open rightward.

The left side cover 112 covers the left opening of the chain chamber 14. An oil pump 621 and an oil cooler 63 are fixed to the left side surface of the left side cover 112.

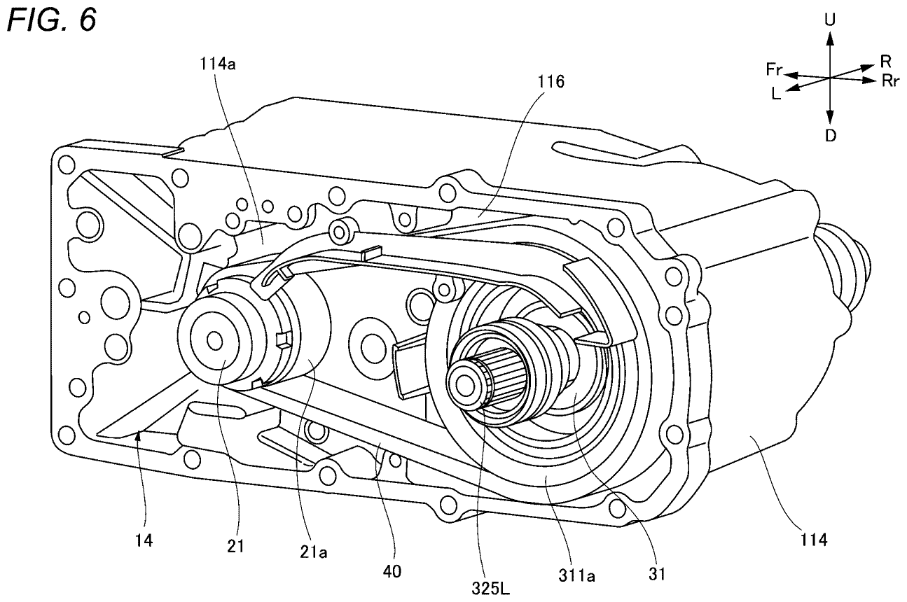

As illustrated in FIGS. 6 to 8, the left main case 114 forms the motor chamber 12, the gear chamber 13, and the chain chamber 14. The left main case 114 includes a first dividing wall 114a dividing the motor chamber 12 and the chain chamber 14, and a second dividing wall 114b dividing the motor chamber 12 and the gear chamber 13. The first dividing wall 114a extends in the upper-lower direction and the front-rear direction between the drive sprocket 21a and the drive motor 20. The second dividing wall 114b extends in the upper-lower direction and the left-right direction between the drive motor 20 and the speed reducer 30.

In the left main case 114, the motor chamber 12 is open rightward. In the left main case 114, the gear chamber 13 and the chain chamber 14 communicate with each other, whereas the left main case 114 is provided with a baffle plate 116 partitioning the gear chamber 13 and the chain chamber 14 (see also FIG. 4). The baffle plate 116 extends in the upper-lower direction and the front-rear direction between the driven sprocket 311a and the sun gear 312.

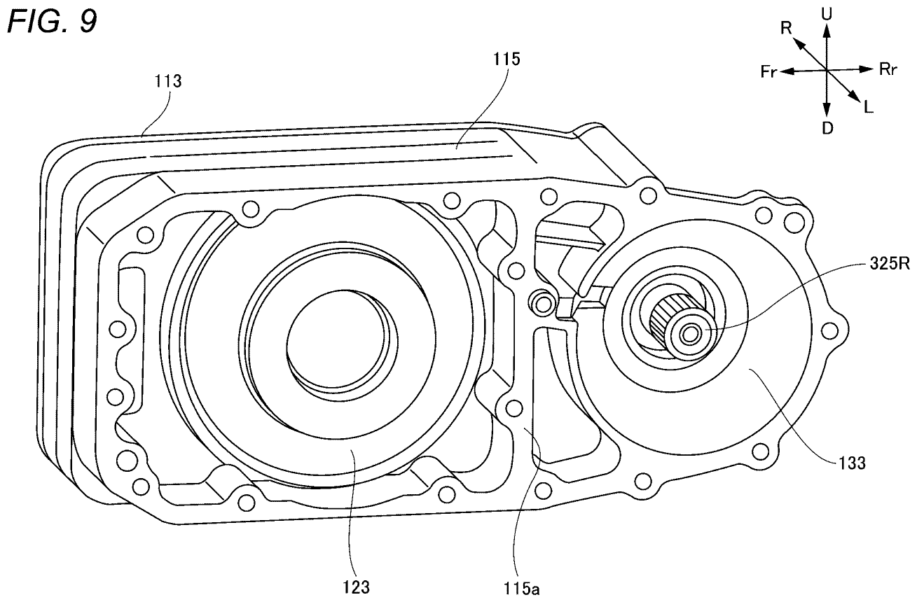

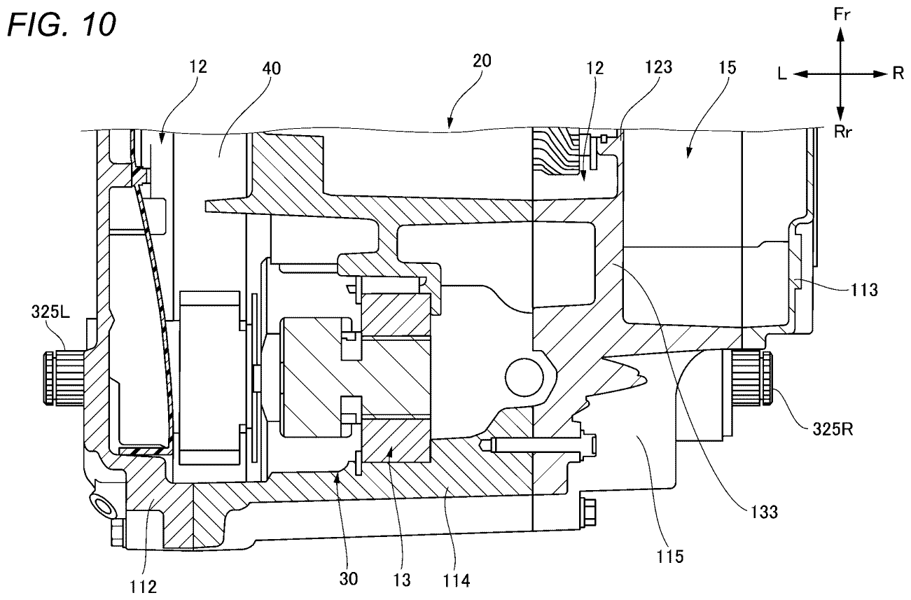

As illustrated in FIGS. 9 and 10, the right main case 115 includes a right wall 123 that covers the right opening of the motor chamber 12 formed in the left main case 114. The right main case 115 further includes a right wall 133 that covers the right opening of the gear chamber 13 formed in the left main case 114, and a third dividing wall 115a that divides the motor chamber 12 and the gear chamber 13. The right main case 115 forms the controller chamber 15 to the right of the right wall 123 including the front region of the right wall 133. In the right main case 115, the controller chamber 15 is open rightward.

The right side cover 113 covers the right opening of the controller chamber 15.

### Temperature Control System

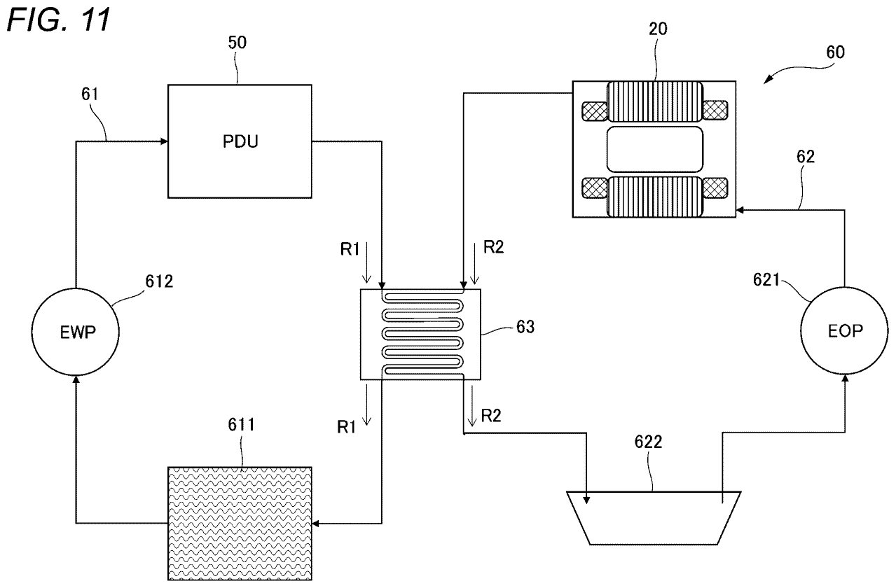

As illustrated in FIG. 11, the vehicle V includes a temperature control system 60. The temperature control system 60 includes a first temperature control circuit 61 for circulating the above-described cooling water RI and performing temperature control of the control device 50, a second temperature control circuit 62 for circulating the above-described motor cooling oil R2 and performing temperature control and lubrication of the drive motor 20, and the oil cooler 63 described above. As described above, the oil cooler 63 performs heat exchange between the cooling water R1 circulating in the first temperature control circuit 61 and the motor cooling oil R2 circulating in the second temperature control circuit 62.

In the first temperature control circuit 61, the cooling water R1 circulates through the cooling water pump 612, the control device 50, the oil cooler 63, and the radiator 611. The cooling water R1 pressure-fed from the cooling water pump 612 is supplied to the control device 50 to control the temperature of the control device 50, then supplied from the control device 50 to the oil cooler 63 to perform heat exchange with the motor cooling oil R2 flowing through the second temperature control circuit 62, supplied to the radiator 611, cooled by heat exchange with external air, and then returned to the cooling water pump 612.

In the second temperature control circuit 62, the motor cooling oil R2 circulates through the oil pump 621, the drive motor 20, and the oil cooler 63. The inside the drive unit case 11 is formed with a storage portion 622 for temporarily storing the motor cooling oil R2 cooled by the oil cooler 63. The motor cooling oil R2 temporarily stored in the storage portion 622 is pressure-fed from the oil pump 621 and supplied into the drive unit case 11 to control the temperature of the drive motor 20. The motor cooling oil R2 is supplied from the drive unit case 11 to the oil cooler 63, cooled by the heat exchange with the cooling water R1 flowing through the first temperature control circuit 61, and then flows into the storage portion 622 and is temporarily stored in the storage portion 622 again.

### Lubrication and Cooling of Gear Chamber and Chain Chamber

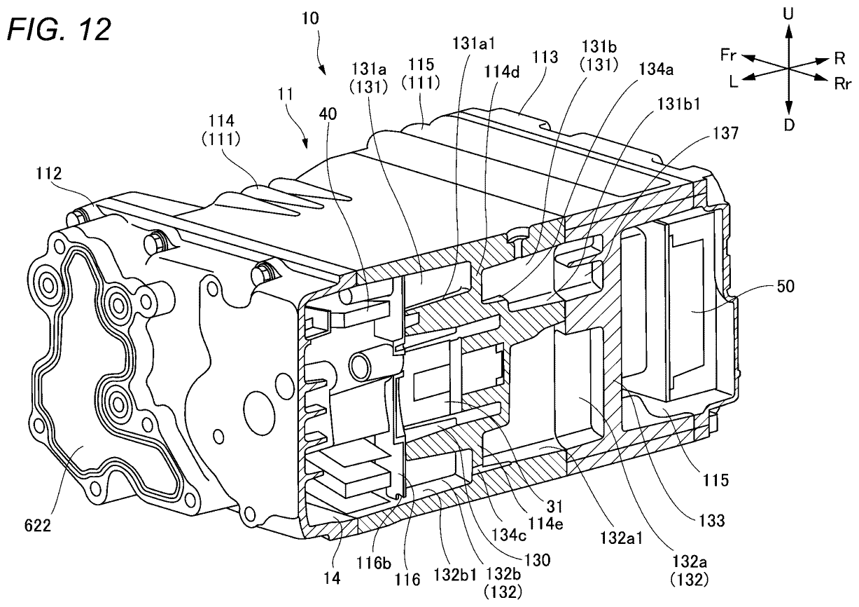

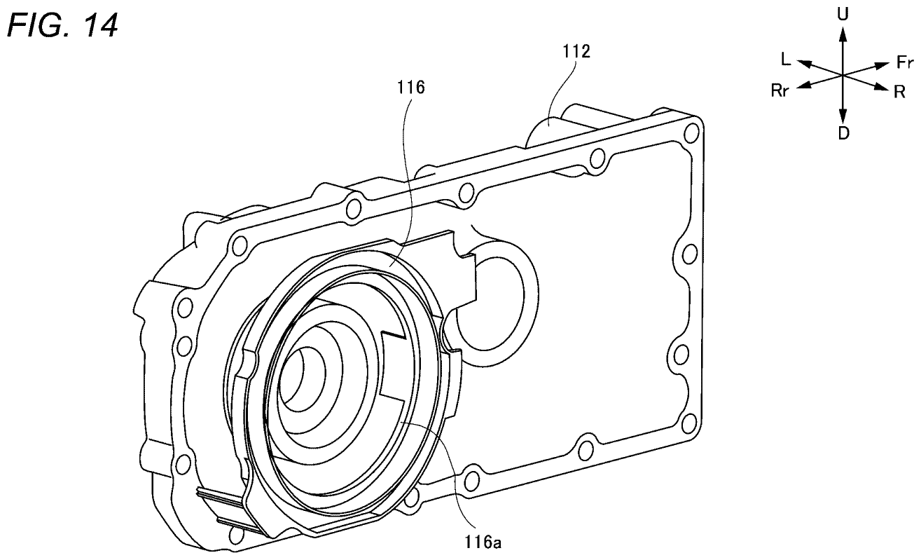

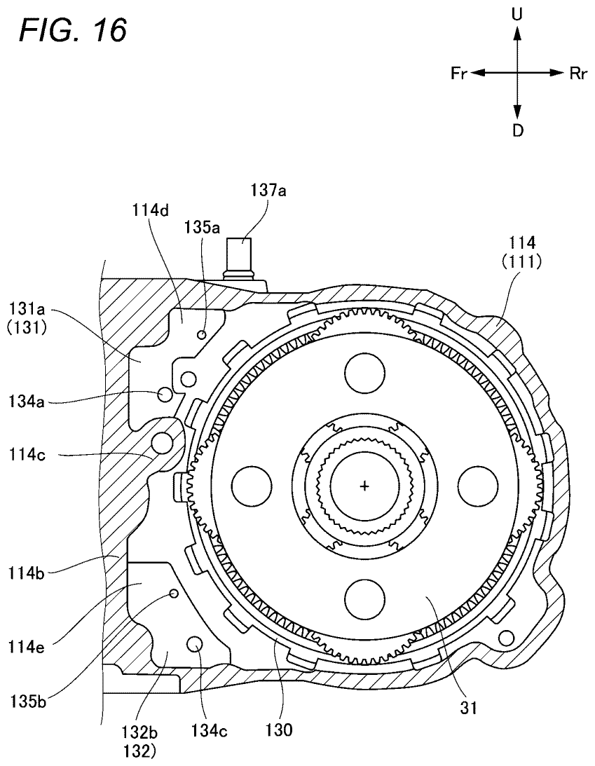

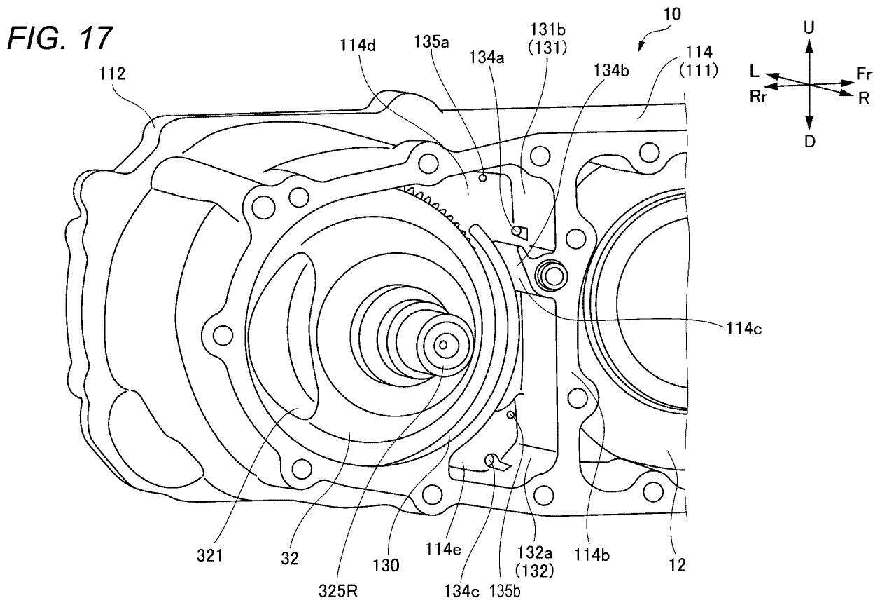

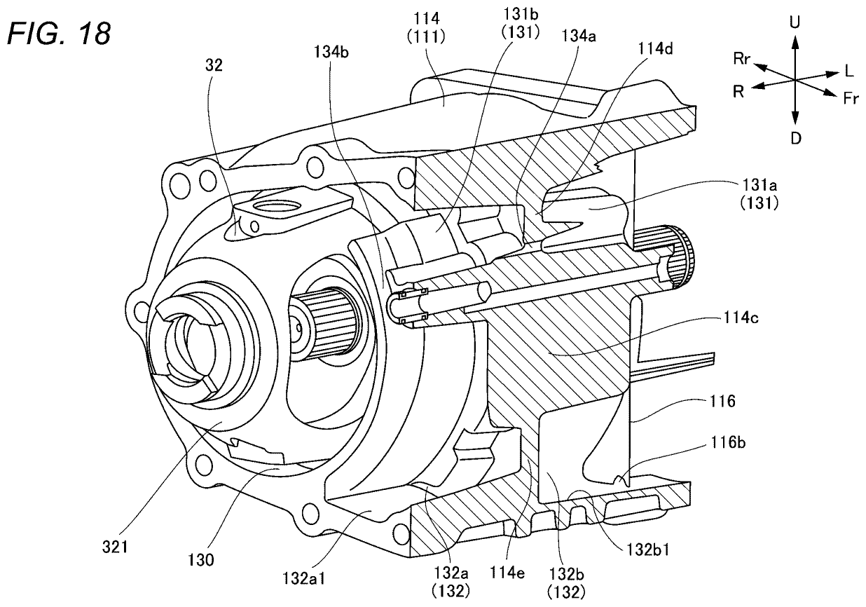

Next, the lubrication and cooling of the gear chamber 13 and the chain chamber 14 will be described with reference to FIGS. 12 to 21.

As illustrated in FIGS. 12 to 14, the gear chamber 13 and the chain chamber 14 partitioned by the baffle plate 116 store a common fluid, that is, a lubrication oil R3. The lubrication oil R3 is, for example, oil called ATF (automatic transmission fluid). The lubrication oil R3 may be the same oil as the motor cooling oil R2, but is not mixed with the motor cooling oil R2 circulating through the second temperature control circuit 62. The lubrication oil R3 lubricates the speed reducer 30 provided in the gear chamber 13, and the drive sprocket 21a, the driven sprocket 311a, the power transmission chain 40, and the like provided in the chain chamber 14.

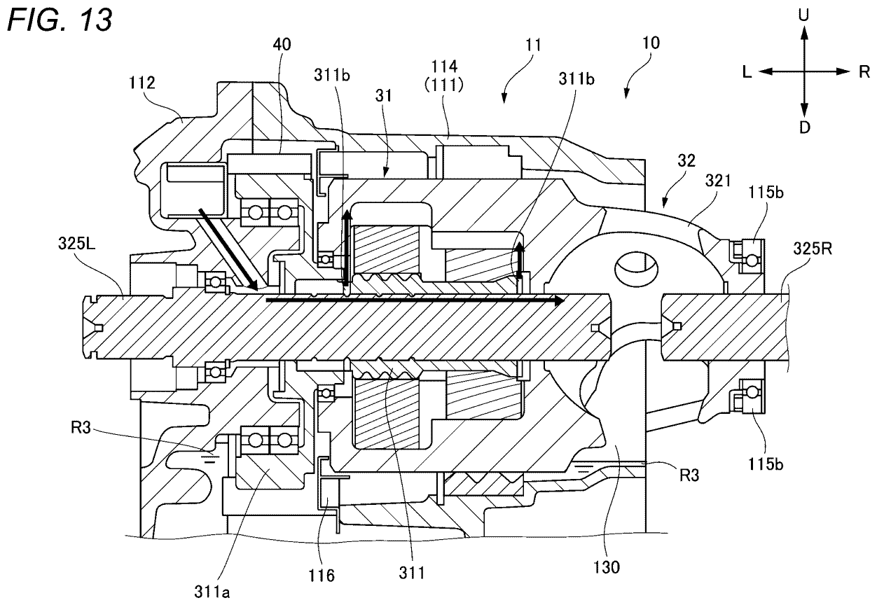

Specifically, in the chain chamber 14, the lower portion of the driven sprocket 311a is immersed in the lubrication oil R3 stored in the lower portion of the chain chamber 14 (see FIG. 13). The, the lubrication oil R3 stored in the lower portion of the chain chamber 14 is scooped up by the driven sprocket 311a. The lubrication oil R3 scooped up by the driven sprocket 311a lubricates and cools the drive sprocket 21a, the driven sprocket 311a, the power transmission chain 40, and the like provided in the chain chamber 14.

Therefore, the scooping efficiency the driven sprocket 311a is improved as the height of the liquid surface of the lubrication oil R3 of the chain chamber 14 increases.

In the gear chamber 13, the lubrication oil R3 scooped up by the driven sprocket 311a in the chain chamber 14 is supplied to the gear chamber 13 through the inside of the input shaft 311. The lubrication oil R3 supplied from the chain chamber 14 lubricates and cools the speed reducer 30.

Specifically, the outer peripheral wall of the hollow input shaft 311 is formed with, along the axial direction, a plurality of oil supply holes 311b penetrating in the radial direction. The lubrication oil R3 supplied into the hollow input shaft 311 is discharged radially outward from the oil supply holes 311b by the centrifugal force generated due to the rotation of the input shaft 311. The lubrication oil R3 discharged radially outward from the oil supply holes 311b lubricates and cools the planetary gear mechanism 31. On the other hand, the lubrication oil R3 not discharged from the oil supply holes 311b flows from the left to the right in the axial direction inside the input shaft 311, and is discharged from the right end of the input shaft 311. The lubrication oil R3 discharged from the right end of the input shaft 311 is supplied to the differential gear mechanism 32 to lubricate and cool the differential gear mechanism 32.

Therefore, the speed reducer 30 can be sufficiently lubricated and cooled even if the amount of the lubrication oil R3 discharged from the oil supply holes 311b of the hollow input shaft 311 is increased and the height of the liquid surface of the lubrication oil R3 in the gear chamber 13 is lowered. Therefore, if the amount of the lubrication oil R3 discharged from the oil supply holes 311b of the hollow input shaft 311 is increased and the height of the liquid surface of the lubrication oil R3 in the gear chamber 13 is lowered, the stirring resistance when stirring the lubrication oil R3 by the rotation of the speed reducer 30 is reduced and the loss during the rotation of the speed reducer 30 is lowered.

In this way, the height of the liquid surface of the lubrication oil R3 of the chain chamber 14 is desirably high, and the height of the liquid surface of the lubrication oil R3 of the gear chamber 13 is desirably low.

The gear chamber 13 is formed with an accommodating chamber 130 that accommodates the planetary gear mechanism 31 and the differential gear mechanism 32. The accommodating chamber 130 has a substantially circular cross section as viewed in the rotary shaft direction of the planetary gear mechanism 31 and the differential gear mechanism 32. The lower portion of the accommodating chamber 130 stores a part of the lubrication oil R3 supplied from the chain chamber 14 to the gear chamber 13 through the inside of the input shaft 311. The lower portion of the planetary gear mechanism 31 and the lower portion of the differential gear mechanism 32 are immersed in the lubrication oil R3 stored in the lower portion of the accommodating chamber 130 (see FIG. 13). The lubrication oil R3 stored in the lower portion of the accommodating chamber 130 is scooped up due to the rotation of the planetary gear mechanism 31 and the differential gear mechanism 32, which are also lubricated and cooled by the lubrication oil R3 scooped up due to the rotation of the planetary gear mechanism 31 and the differential gear mechanism 32.

In the present embodiment, as described above, in the left main case 114, the gear chamber 13 and the chain chamber 14 communicate with each other, whereas the left main case 114 is provided with the baffle plate 116 partitioning the gear chamber 13 and the chain chamber 14. The baffle plate 116 extends in the upper-lower direction and the front-rear direction between the driven sprocket 311a and the sun gear 312.

The baffle plate 116 extends upward from the bottom of the chain chamber 14 and the gear chamber 13, and limits the flow of the lubrication oil R3 between the chain chamber 14 and the gear chamber 13.

Accordingly, the height of the liquid surface of the lubrication oil R3 of the chain chamber 14 can be made different from the height of the liquid surface of the lubrication oil R3 of the gear chamber 13. The height of the liquid surface of the lubrication oil R3 of the chain chamber 14 can be made high, and the height of the liquid surface of the lubrication oil R3 of the gear chamber 13 can be made low. Accordingly, it is possible to reduce the stirring resistance of the lubrication oil R3 caused by the rotation of the speed reducer 30 while enhancing the lubrication performance in the gear chamber 13 and the chain chamber 14.

In the present embodiment, the height of the liquid surface of the lubrication oil R3 of the chain chamber 14 and the height of the liquid surface of the lubrication oil R3 of the gear chamber 13 are different.

Accordingly, the height of the liquid surface of the lubrication oil R3 of the chain chamber 14 and the height of the liquid surface of the lubrication oil R3 of the gear chamber 13 can be optimized individually.

In the present embodiment, the height of the liquid surface of the lubrication oil R3 of the gear chamber 13 is lower than the height of the liquid surface of the lubrication oil R3 of the chain chamber 14.

Accordingly, it is possible to reduce the stirring resistance of the lubrication oil R3 caused by the rotation of the speed reducer 30 while enhancing the lubrication performance in the gear chamber 13 and the chain chamber 14.

The baffle plate 116 is a plate-shaped member having a circular opening 116a at the center. The input shaft 311 is inserted into the opening 116a. As described above, the input shaft 311 is provided with the sun gear 312, and has the driven sprocket 311a attached to the left of the sun gear 312.

As described above, the baffle plate 116 does not only partition the lower portion of the chain chamber 14 and the gear chamber 13, but also extends radially outward around the input shaft 311. Therefore, the height of the liquid surface of the lubrication oil R3 in the chain chamber 14 and the height of the liquid surface of the lubrication oil R3 in the gear chamber 13 can be made different from each other. In addition, the lubrication oil R3 scattered due to the rotation of the driven sprocket 311a and the speed reducer 30 can be restricted from flowing between the chain chamber 14 and the gear chamber 13.

In the present embodiment, the planetary gear mechanism 31 is rotated counterclockwise as viewed from the left. Further, since the ring gear 317 is fixed to the drive unit case 11, the sun gear 312 rotates counterclockwise as viewed from the left, and the first planetary gears 314a engaged with the sun gear 312 and the second planetary gears 314b formed integrally with the first planetary gear 314a and meshed with the ring gear 317 revolve counterclockwise as viewed from the left while rotating clockwise as viewed from the left.

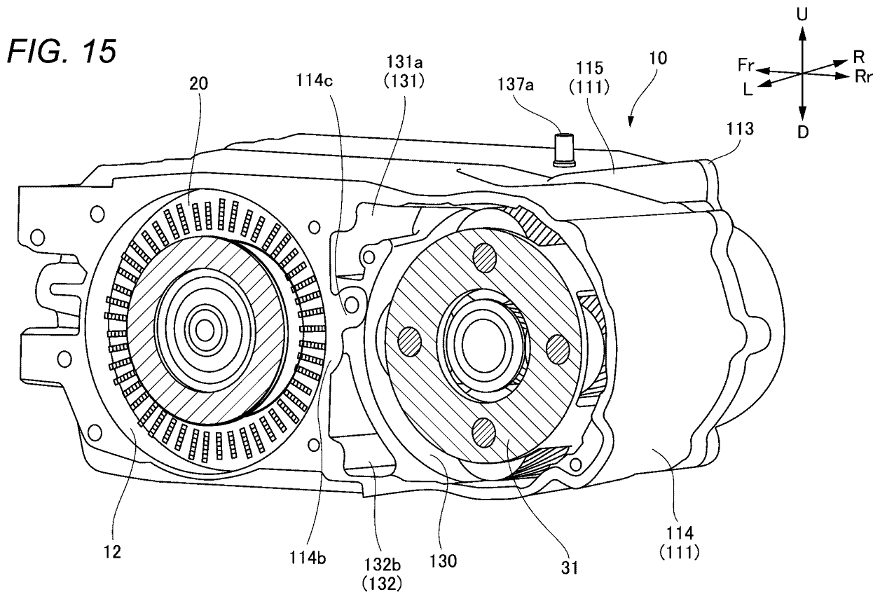

As illustrated in FIGS. 15 to 19, the upper portion of the gear chamber 13 is formed with an upper space 131. The upper space 131 is formed between the motor chamber 12 and the accommodating chamber 130 of the gear chamber 13. The upper space 131 is formed in the accommodating chamber 130 and communicates with the accommodating chamber 130. The upper space 131 is formed by the wall of the drive unit case 11 on the rotation direction side (front side in the present embodiment) of the upper end of the input shaft 311, that is, by the second dividing wall 114b in the present embodiment.

The lower portion of the gear chamber 13 is formed with a lower space 132. The lower space 132 is partitioned to be separate from the accommodating chamber 130.

The lower space 132 is formed below the upper space 131. The lower space 132 is formed between the motor chamber 12 and the accommodating chamber 130 of the gear chamber 13. The upper space 131 and the lower space 132 are separated by an upper-lower dividing wall 114c extending rearward from the second dividing wall 114b.

The upper space 131 and the lower space 132 are formed between the motor chamber 12 and the accommodating chamber 130 of the gear chamber 13, and both store the lubrication oil R3.

Accordingly, the upper space 131 and the lower space 132 can be provided while limiting an increase in the upper-lower dimension of the drive unit case 11. By storing the lubrication oil R3 in the upper space 131 and the lower space 132, the height of the liquid surface of the lubrication oil R3 stored in the lower portion of the accommodating chamber 130 can be lowered. This can further reduce the stirring resistance of the lubrication oil R3 caused by the rotation of the speed reducer 30.

On the other hand, the upper space 131 and the lower space 132 do not allow the motor cooling oil R2 to flow in.

Accordingly, the motor cooling oil R2 and the lubrication oil R3 are not mixed, so that the motor cooling oil R2 and the lubrication oil R3 can be divided into different contamination levels, and the lubrication oil R3, which tends to contain a large amount of sludge, can be prevented from being supplied to the drive motor 20.

The motor chamber 12 has a substantially circular cross section as viewed in the output rotary shaft direction of the drive motor 20. The accommodating chamber 130 has a substantially circular cross-section as viewed in the output rotary shaft direction of the speed reducer 30.

As viewed in the rotary shaft direction of the drive motor 20, the planetary gear mechanism 31, and the differential gear mechanism 32, that is, the left-right direction, the upper space 131 is formed in a region between the motor chamber 12 and the accommodating chamber 130 and above the rotary shaft of the drive motor 20 and the rotary shafts of the planetary gear mechanism 31 and the differential gear mechanism 32. The lower space 132 is formed in a region between the motor chamber 12 and the accommodating chamber 130 and below the rotary shaft of the drive motor 20 and the rotary shafts of the planetary gear mechanism 31 and the differential gear mechanism 32.

Accordingly, it is possible to effectively use the space in the regions between the motor chamber 12 and the accommodating chamber 130 as viewed in the output rotary shaft direction of the drive motor 20 and the speed reducer 30, that is, the left-right direction, and above and below the output rotary shaft of the drive motor 20 and the output rotary shaft of the speed reducer 30. Therefore, the upper space 131 and the lower space 132 serving as the storage portion for storing the lubrication oil R3 can be provided while limiting an increase in upper-lower dimension of the drive unit case 11.

As viewed in the direction of a virtual straight line VL1 (in the present embodiment, the front-rear direction) orthogonal to the output rotary shaft of the drive motor 20 and the output rotary shaft of the speed reducer 30, the upper space 131 and the lower space 132 are both at least partially overlapped with the motor chamber 12 and the accommodating chamber 130.

Accordingly, the projection area of the drive unit case 11 as viewed in the direction of the virtual straight line VL1 (the front-rear direction in the present embodiment) can be reduced. This can downsize the drive unit case 11.

In particular, in the present embodiment, both the upper space 131 and the lower space 132 have half or more of the projection area viewed in the direction of the virtual straight line VL1 (in the present embodiment, the front-rear direction) overlapped with the motor chamber 12 and the accommodating chamber 130.

Accordingly, the projection area of the drive unit case 11 as viewed in the direction of the virtual straight line VL1 (the front-rear direction in the present embodiment) can be further reduced. This can further downsize the drive unit case 11.

The upper space 131 extends in the axial direction of the output rotary shaft of the speed reducer 30, and is divided into a planetary-side upper storage portion 131a and a differential-side upper storage portion 131b in the axial direction of the output rotary shaft of the speed reducer 30.

The lower space 132 extends in the axial direction of the output rotary shaft of the speed reducer 30, and is divided into a differential-side lower storage chamber 132a and a planetary-side lower storage chamber 132b in the axial direction of the output rotary shaft of the speed reducer 30.

In this way, since the upper space 131 and the lower space 132 are formed longer in the axial direction of the output rotary shaft of the speed reducer 30 and are divided into a plurality of spaces in the axial direction of the output rotary shaft of the speed reducer 30, it is possible to increase the time for the lubrication oil R3 to stay in the upper space 131. Accordingly, it is possible to eliminate the foams of the foamed lubrication oil R3, and to lower the temperature of the lubrication oil R3.

The upper space 131, that is, the planetary-side upper storage portion 131a and the differential-side upper storage portion 131b are integrally formed by casting in the drive unit case 11 (the left main case 114 in the present embodiment).

Similarly, the lower space 132, that is, the differential-side lower storage chamber 132a and the planetary-side lower storage chamber 132b are integrally formed by casting in the drive unit case 11 (the left main case 114 in the present embodiment).

Accordingly, the upper space 131 and the lower space 132, more specifically, the planetary-side upper storage portion 131a, the differential-side upper storage portion 131b, the differential-side lower storage chamber 132a, and the planetary-side lower storage chamber 132b can be formed at low cost.

The planetary-side upper storage portion 131a is provided above the rotary shaft of the input shaft 311 and below the upper end of the planetary gear mechanism 31 in the upper-lower direction, and at a position where at least a part thereof is overlapped with the planetary gear mechanism 31 in the axial direction of the input shaft 311. The position where at least a part thereof is overlapped with the planetary gear mechanism 31 in the axial direction of the input shaft 311 refers to a position where at least a part thereof is overlapped with the planetary gear mechanism 31 in the axial direction of the input shaft 311 as viewed in a predetermined direction on the radially outer side of the input shaft 311 toward the center of the input shaft 311.

The planetary-side upper storage portion 131a captures and stores a part of the lubrication oil R3 scooped up from the lower portion of the accommodating chamber 130 by the planetary gear mechanism 31 and scattered.

In addition, the planetary-side upper storage portion 131a captures and stores a part of the lubrication oil R3 discharged and scattered radially outward from the oil supply holes 311b of the input shaft 311.

Accordingly, by the planetary-side upper storage portion 131a capturing the lubrication oil R3 discharged and scattered radially outward from the oil supply holes 311b of the input shaft 311 and the lubrication oil R3 scooped up by the planetary gear mechanism 31 and scattered, the height of the liquid surface of the lubrication oil R3 stored in the lower portion of the accommodating chamber 130 can be further lowered. Therefore, the stirring resistance of the lubrication oil R3 due to the rotation of the speed reducer 30 can be further reduced. In this way, the dimension in the height direction of the drive unit 10 can be limited without lowering the power transmission efficiency.

The differential-side upper storage portion 131b is provided above the rotary shaft of the differential case 321 and below the upper end of the differential case 321 in the upper-lower direction, and at a position where at least a part thereof is overlapped with the differential gear mechanism 32 in the rotary shaft direction of the differential case 321. The position where at least a part thereof is overlapped with the differential gear mechanism 32 in the rotary shaft direction of the differential case 321 refers to a position where at least a part thereof is overlapped with the differential gear mechanism 32 in the rotary shaft direction of the differential case 321 as viewed in a predetermined direction on the radially outer side of the differential case 321 toward the rotation axis of the differential case 321.

The differential-side upper storage portion 131b captures and stores a part of the lubrication oil R3 scooped up by the differential gear mechanism 32 including the differential case 321 and scattered from the lubrication oil R3 stored in the lower portion of the gear chamber 13.

In addition, the differential-side upper storage portion 131b captures and stores a part of the lubrication oil R3 discharged from the right end of the input shaft 311 toward the differential gear mechanism 32 and scattered due to the rotation of the differential gear mechanism 32.

Accordingly, by the differential-side upper storage portion 131b capturing the lubrication oil R3 discharged from the right end of the input shaft 311 toward the differential gear mechanism 32 and scattered due to the rotation of the differential gear mechanism 32, and the lubrication oil R3 scooped up by the differential gear mechanism 32 including the differential case 321 and scattered from the lower portion of the accommodating chamber 130, the height of the liquid surface of the lubrication oil R3 stored in the lower portion of the accommodating chamber 130 can be further lowered. Therefore, the stirring resistance of the lubrication oil R3 due to the rotation of the speed reducer 30 can be further reduced.

In the left main case 114, the planetary-side upper storage portion 131a and the differential-side upper storage portion 131b are adjacent in the rotary shaft direction of the planetary gear mechanism 31 and the differential gear mechanism 32 with the upper dividing wall 114d interposed therebetween. The upper dividing wall 114d is provided with a first oil flow hole 134a that communicates the planetary-side upper storage portion 131a and the differential-side upper storage portion 131b and allows the lubrication oil R3 to flow through.

Accordingly, the lubrication oil R3 stored in the planetary-side upper storage portion 131a can flow to the differential-side upper storage portion 131b.

Further, the height of the bottom surface 131a1 of the planetary-side upper storage portion 131a is higher than the height of the bottom surface 131b1 of the differential-side upper storage portion 131b.

Accordingly, the lubrication oil R3 stored in the planetary-side upper storage portion 131a can easily flow to the differential-side upper storage portion 131b.

In addition, in the left main case 114, the upper dividing wall 114d is provided with a first ventilation hole 135a above the first oil flow hole 134a, so that the planetary-side upper storage portion 131a and the differential-side upper storage portion 131b communicate with each other, and the gas flows between the planetary-side upper storage portion 131a and the differential-side upper storage portion 131b.

Accordingly, the pressure in the planetary-side upper storage portion 131a and the differential-side upper storage portion 131b is prevented from increasing due to the gas in the planetary-side upper storage portion 131a and the differential-side upper storage portion 131b. This can prevent the difficulty for the lubrication oil R3 stored in the planetary-side upper storage portion 131a to flow into the differential-side upper storage portion 131b.

The differential-side lower storage chamber 132a is provided below the differential-side upper storage portion 131b. In the left main case 114, the differential-side upper storage portion 131b and the differential-side lower storage chamber 132a are adjacent in the upper-lower direction with the upper-lower dividing wall 114c interposed therebetween. That is, the upper-lower dividing wall 114c forms the bottom wall of the differential-side upper storage portion 131b and the upper wall of the differential-side lower storage chamber 132a. The upper-lower dividing wall 114c is provided with a second oil flow hole 134b that communicates the differential-side upper storage portion 131b and the differential-side lower storage chamber 132a and allows the lubrication oil R3 to flow through.

As described above, in the lower portion of the gear chamber 13, since the lower space 132 is partitioned separate from the accommodating chamber 130, the differential-side lower storage chamber 132a is also separate from the accommodating chamber 130. Therefore, the lubrication oil R3 flowing from the planetary-side upper storage portion 131a to the differential-side upper storage portion 131b and stored in the differential-side upper storage portion 131b does not flow into the accommodating chamber 130, but flows through the second oil flow hole 134b into the differential-side lower storage chamber 132a, which is separate from the accommodating chamber 130.

Accordingly, the height of the liquid surface of the lubrication oil R3 stored in the accommodating chamber 130 can be maintained at a lower level. Therefore, the stirring resistance of the lubrication oil R3 when the speed reducer 30 rotates can be further reduced.

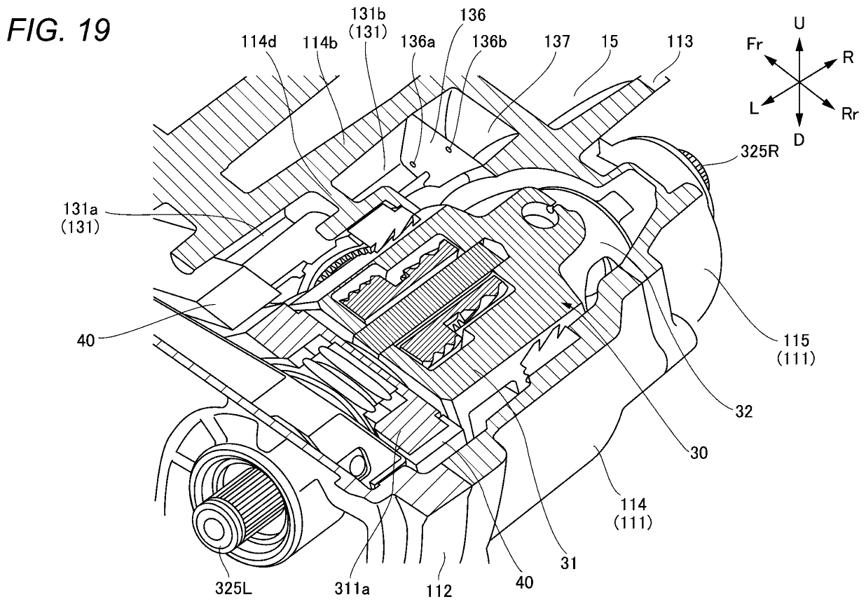

As illustrated in FIG. 19, the left main case 114 and the right main case 115 are assembled with a gasket 136 sandwiched therebetween. The gasket 136 is a plate-shaped member extending in the upper-lower direction and the front-rear direction. The differential-side upper storage portion 131b is formed on the left side of the gasket 136, and the wall of the differential-side upper storage portion 131b is formed by the left main case 114 and the gasket 136. The gasket 136 forms at least a part of the right wall of the differential-side upper storage portion 131b. The right side of the gasket 136 is formed with a breather chamber 137 adjacent to the differential-side upper storage portion 131b with the gasket 136 interposed therebetween. The wall of the breather chamber 137 is formed by the right main case 115 and the gasket 136. The gasket 136 forms at least a part of the left wall of the breather chamber 137.

Accordingly, it is possible to form the wall of the differential-side upper storage portion 131b and the breather chamber 137 at a low cost while limiting the weight increase.

The gasket 136 is provided with an oil flow hole 136a that communicates the differential-side upper storage portion 131b and the breather chamber 137 and that passes the remaining lubrication oil R3 that does not flow into the second oil flow hole 134b among the lubrication oil R3 stored in the differential-side upper storage portion 131b. Further, above the oil flow hole 136a, the gasket 136 is provided with a communication hole 136b that communicates the differential-side upper storage portion 131b and the breather chamber 137 and allows the gas and the mist of the lubrication oil R3 from the differential-side upper storage portion 131b and the breather chamber 137 to flow through.

Accordingly, it is possible to easily form the oil flow hole 136a and the communication hole 136b that communicates the differential-side upper storage portion 131b and the breather chamber 137.

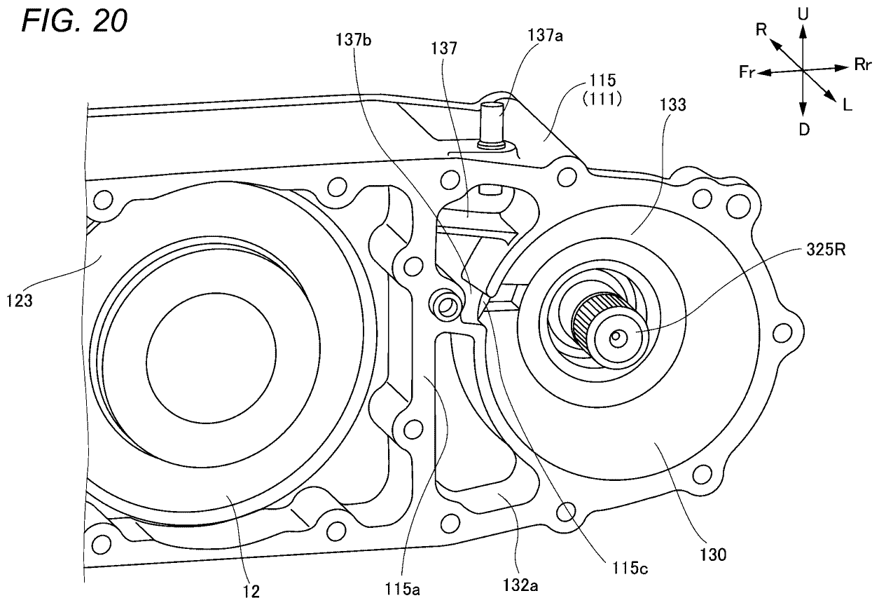

As illustrated in FIG. 20, the upper portion of the breather chamber 137 is provided with a breather hole 137a communicating with the outside of the drive unit case 11. When the pressure in the gear chamber 13 exceeds the predetermined pressure, gas is released from the breather hole 137a, and the pressure in the gear chamber 13 is maintained at or below the predetermined pressure.

In addition, in the flow direction of the lubrication oil R3 in the drive unit case 11, the breather chamber 137 and the breather hole 137a are provided after passing through the planetary-side upper storage portion 131a and the differential-side upper storage portion 131b for storing the lubrication oil R3. Accordingly, the breather chamber 137 and the breather hole 137a can be formed at the deep portion of the drive unit case 11. This ca limit contamination such as external dirt or water from being mixed into the lubrication oil R3. Further, since the breather chamber 137 and the breather hole 137a can be formed at positions far from the heat sources such as the drive motor 20 and the speed reducer 30, the lubrication oil R3 can be prevented from being thermally expanded and blown out of the drive unit case 11.

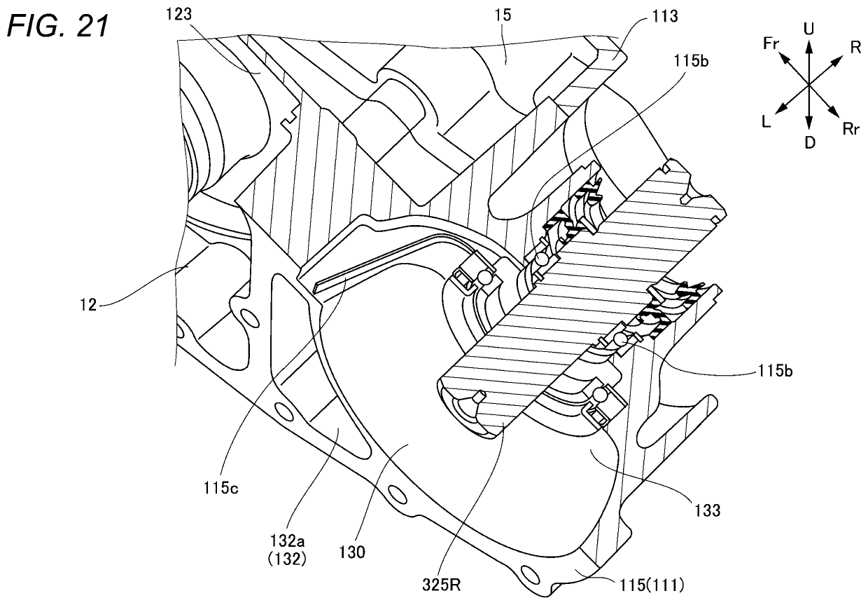

As illustrated in FIGS. 20 and 21, the drive unit case 11 (in the present embodiment, the right main case 115) is provided with a right drive shaft bearing 115b that pivotally supports the right drive shaft 325R.

The bottom of the breather chamber 137 is provided a breather drain hole 137b for discharging, from the breather chamber 137, the lubrication oil R3 that enters the breather chamber 137 from the differential-side upper storage portion 131b through the oil flow hole 136a, and the lubrication oil R3 that enters the breather chamber 137 from the differential-side upper storage portion 131b through the communication hole 136b and is condensed into a liquid in the breather chamber 137 and stored in the lower portion of the breather chamber 137. The breather drain hole 137b communicates the breather chamber 137 and the accommodating chamber 130. The drive unit case 11 (in the present embodiment, the right main case 115) is formed with an oil guide portion 115c for guiding, to the right drive shaft bearing 115b, the lubrication oil R3 that flows out from the breather drain hole 137b to the accommodating chamber 130.

Accordingly, the lubrication oil R3 condensed in the breather chamber 137 and stored in the lower portion of the breather chamber 137 is discharged from the breather drain hole 137b, and the right drive shaft bearing 115b can be lubricated by the lubrication oil R3 discharged from the breather drain hole 137b. Therefore, the right drive shaft bearing 115b can be lubricated efficiently by utilizing the lubrication oil R3 stored in the lower portion of the breather chamber 137.

Further, the lubrication oil R3 condensed in the breather chamber 137 and stored in the lower portion of the breather chamber 137 can be discharged from the breather chamber 137 and return to the accommodating chamber 130.

In the present embodiment, the oil guide portion 115c has a gutter shape extending from the right main case 115, and is formed integrally with the right main case 115 by casting. The opening surface of the oil guide portion 115c is covered by a plate-shaped side surface member.

Accordingly, the oil guide portion 115c can be formed at a lower cost.

Returning to FIGS. 15 to 19, the planetary-side lower storage chamber 132b is provided adjacent to the left side of the differential-side lower storage chamber 132a. In the left main case 114, the differential-side lower storage chamber 132a and the planetary-side lower storage chamber 132b are adjacent in the left-right direction with the lower dividing wall 114e interposed therebetween. That is, the lower dividing wall 114e forms the left wall of the differential-side lower storage chamber 132a and the right wall of the planetary-side lower storage chamber 132b. The lower dividing wall 114e is provided with a third oil flow hole 134c that communicates the differential-side lower storage chamber 132a and the planetary-side lower storage chamber 132b and allows the lubrication oil R3 to flow through.

As described above, in the lower portion of the gear chamber 13, since the lower space 132 is partitioned separate from the accommodating chamber 130, the planetary-side lower storage chamber 132b is also separate from the accommodating chamber 130. Therefore, the lubrication oil R3 that flows into the differential-side lower storage chamber 132a does not flow into the accommodating chamber 130, but flows through the third oil flow hole 134c into the planetary-side lower storage chamber 132b, which is separate from the accommodating chamber 130.

Accordingly, the height of the liquid surface of the lubrication oil R3 stored in the accommodating chamber 130 can be maintained at a lower level. Therefore, the stirring resistance of the lubrication oil R3 when the speed reducer 30 rotates can be further reduced.

Moreover, since the lubrication oil R3 flows from the differential-side lower storage chamber 132a to the planetary-side lower storage chamber 132b through the third oil flow hole 134c, by setting the diameter of the third oil flow hole 134c to be small, the movement speed of the lubrication oil R3 from the differential-side lower storage chamber 132a to the planetary-side lower storage chamber 132b can be reduced. Accordingly, the movement time for the lubrication oil R3 to move from the differential-side lower storage chamber 132a to the planetary-side lower storage chamber 132b can be made longer. This can further release the air bubbles in the lubrication oil R3, and lower the temperature of the lubrication oil R3.

In addition, in the left main case 114, the lower dividing wall 114e is provided with a second ventilation hole 135b above the third oil flow hole 134c, so that the differential-side lower storage chamber 132a and the planetary-side lower storage chamber 132b communicate with each other, and the gas flows between the differential-side lower storage chamber 132a and the planetary-side lower storage chamber 132b.

Accordingly, the pressure in the differential-side lower storage chamber 132a and the planetary-side lower storage chamber 132b is prevented from increasing due to the gas in the differential-side lower storage chamber 132a and the planetary-side lower storage chamber 132b. This can prevent the difficulty for the lubrication oil R3 stored in the differential-side lower storage chamber 132a to flow into the planetary-side lower storage chamber 132b.

Further, the height of the bottom surface 132a1 of the differential-side lower storage chamber 132a is higher than the height of the bottom surface 132b1 of the planetary-side lower storage chamber 132b.

Accordingly, the lubrication oil R3 stored in the differential-side lower storage chamber 132a can easily flow to the planetary-side lower storage chamber 132b.

At least a part of the left wall of the planetary-side lower storage chamber 132b is formed by the baffle plate 116 described above. Therefore, the planetary-side lower storage chamber 132b and the chain chamber 14 are divided by the baffle plate 116.

Accordingly, it is possible to form the planetary-side lower storage chamber 132b at a low cost while limiting the weight increase.

The baffle plate 116 is provided with an oil discharge hole 116b that communicates the planetary-side lower storage chamber 132b and the chain chamber 14 and allows the lubrication oil R3 to flow through.

Therefore, the lubrication oil R3 supplied from the chain chamber 14 to the gear chamber 13 through the inside of the input shaft 311 lubricates and cools the speed reducer 30, and then is stored in the accommodating chamber 130, scooped up due to the rotation of the speed reducer 30, partially captured by the planetary-side upper storage portion 131a and the differential-side upper storage portion 131b, flows through the differential-side upper storage portion 131b, the differential-side lower storage chamber 132a, and the planetary-side lower storage chamber 132b, and then returns to the chain chamber 14 through the oil discharge hole 116b.

In this way, the oil discharge hole 116b for discharging the lubrication oil R3 circulated in the gear chamber 13 from the gear chamber 13 can be easily formed.

Although an embodiment of the present disclosure has been described above with reference to the accompanying drawings, it is needless to say that the present invention is not limited to the embodiment. It is apparent that those skilled in the art can conceive of various modifications and alterations within the scope described in the claims, and it is understood that such modifications and alterations naturally fall within the technical scope of the present invention. In addition, the components in the above embodiment may be freely combined without departing from the gist of the invention.

In the present description, at least the following matters are described. In the parentheses, corresponding components and the like in the above embodiment are illustrated as an example, but the present invention is not limited thereto.
(1) A drive unit (drive unit 10) including:
a drive motor (drive motor 20);
a speed reducer (speed reducer 30) configured to output power of the drive motor at a reduced speed; and
a drive unit case (drive unit case 11) configured to accommodate the drive motor and the speed reducer,
in which an output rotary shaft of the drive motor and an output rotary shaft of the speed reducer are arranged in parallel and aligned in a horizontal direction,
the drive unit case has:
   a motor chamber (motor chamber 12) in which the drive motor is accommodated; and
   a gear chamber (gear chamber 13) provided with an accommodating chamber (accommodating chamber 130) in which the speed reducer is accommodated,
the motor chamber and the gear chamber are divided by a dividing wall (second dividing wall 114b), and
an upper space (upper space 131) and a lower space (lower space 132) separated in an upper-lower direction by an upper-lower dividing wall (upper-lower dividing wall 114c) extending from the dividing wall are formed between the motor chamber and the accommodating chamber.

According to (1), the upper space and the lower space can be provided in the drive unit case while limiting an increase in upper-lower dimension of the drive unit case.
(2) The drive unit according to (1),
in which the motor chamber has a substantially circular cross section as viewed in an output rotary shaft direction of the drive motor, and
the accommodating chamber has a substantially circular cross section as viewed in an output rotary shaft direction of the speed reducer.

According to (2), it is possible to effectively use the space in the regions between the motor chamber and the accommodating chamber as viewed in the output rotary shaft direction of the drive motor and the speed reducer and above and below the output rotary shaft of the drive motor and the output rotary shaft of the speed reducer. Therefore, the upper space and the lower space can be provided while limiting an increase in upper-lower dimension of the drive unit case.
(3) The drive unit according to (1),
in which the upper space and the lower space are at least partially overlapped with the motor chamber and the accommodating chamber, as viewed in a direction of a virtual straight line (virtual straight line VL1) orthogonal to the output rotary shaft of the drive motor and the output rotary shaft of the speed reducer.

According to (3), the projection area of the drive unit case as viewed in the virtual straight line direction can be reduced. This can downsize the drive unit case.
(4) The drive unit according to (1),
in which as viewed in a direction of a virtual straight line (virtual straight line VL1) orthogonal to the output rotary shaft of the drive motor and the output rotary shaft of the speed reducer, the upper space and the lower space have half or more of a projection area, viewed in the direction of the virtual straight line, overlapping with the motor chamber and the accommodating chamber.

According to (4), the projection area of the drive unit case as viewed in the virtual straight line direction can be further reduced. This can further downsize the drive unit case.
(5) The drive unit according to (1),
in which the upper space and the lower space store a lubrication fluid (lubrication oil R3) for lubricating the speed reducer.

According to (5), by storing the lubrication fluid in the upper space and the lower space, the height of the liquid surface of the lubrication fluid stored in the lower portion of the accommodating chamber can be lowered. This can further reduce the stirring resistance of the lubrication fluid caused by the rotation of the speed reducer.
(6) The drive unit according to (5),
in which the upper space and the lower space do not allow a motor cooling fluid (motor cooling oil R2) for cooling the drive motor to flow in.

According to (6), the lubrication fluid for lubricating the speed reducer and the motor cooling fluid for cooling the drive motor are not mixed, so that the lubrication fluid and the motor cooling fluid can be divided into different contamination levels, and the lubrication fluid, which tends to contain a large amount of sludge, can be prevented from being supplied to the drive motor.
(7) The drive unit according to (1),
in which the upper space and the lower space are integrally formed by casting in the drive unit case.

According to (7), the upper space and the lower space can be formed at a low cost.
(8) The drive unit according to (5),
in which the upper space and the lower space extend in an axial direction of the output rotary shaft of the speed reducer.

According to (8), by forming the upper space and the lower space to be longer in the axial direction of the output rotary shaft of the speed reducer, it is possible to increase the time for the lubrication fluid stored in the upper space and the lower space to stay in the upper space and the lower space. Accordingly, it is possible to prevent the lubrication fluid from foaming, and to lower the temperature of the lubrication fluid.
(9) The drive unit according to (8),
in which the upper space and the lower space are divided into a plurality of spaces in the axial direction of the output rotary shaft of the speed reducer.

According to (9), since the upper space and the lower space are divided into a plurality of spaces in the axial direction of the output rotary shaft of the speed reducer, it is possible to further increase the time for the lubrication fluid stored in the upper space and the lower space to stay in the upper space and the lower space. Accordingly, it is possible to prevent the lubrication fluid from foaming, and to lower the temperature of the lubrication fluid.
(10) The drive unit according to (1),
in which the speed reducer includes a planetary gear mechanism (planetary gear mechanism 31).

According to (10), since the speed reducer includes the planetary gear mechanism, it is possible to obtain a desired speed reduction ratio while limiting an increase in dimension in the radial direction relative to the rotary shaft direction of the speed reducer.
(11) The drive unit according to (10),
in which the speed reducer includes a differential gear mechanism (differential gear mechanism 32), and
an input rotary shaft of the planetary gear mechanism and an output rotary shaft of the differential gear mechanism are coaxial.

According to (11), since the input shaft of the planetary gear mechanism and the output shaft of the differential gear mechanism are arranged coaxially, the speed reducer can be further downsized.
(12) The drive unit according to (11),
in which the planetary gear mechanism includes a sun gear (sun gear 312), a plurality of planetary gears (stepped pinions 314), a planetary carrier (planetary carrier 316), and a ring gear (ring gear 317),
power input to the planetary gear mechanism is output from the planetary carrier, and
the planetary carrier and a differential case (differential case 321) of the differential gear mechanism are integrally formed.

According to (12), since the planetary carrier and the differential case are integrally formed, the planetary gear mechanism and the differential gear mechanism can be integrated. This can further downsize the speed reducer.

What is claimed is:

1. A drive unit comprising:
a drive motor;
a speed reducer configured to output power of the drive motor at a reduced speed; and
a drive unit case configured to accommodate the drive motor and the speed reducer,
wherein an output rotary shaft of the drive motor and an output rotary shaft of the speed reducer are arranged in parallel and aligned in a horizontal direction,
the drive unit case has:
a motor chamber in which the drive motor is accommodated; and
a gear chamber provided with an accommodating chamber in which the speed reducer is accommodated,
the motor chamber and the gear chamber are divided by a dividing wall, and
an upper space and a lower space separated in an upper-lower direction by an upper-lower dividing wall extending from the dividing wall are formed between the motor chamber and the accommodating chamber.

2. The drive unit according to claim 1,
wherein the motor chamber has a substantially circular cross section as viewed in an output rotary shaft direction of the drive motor, and
the accommodating chamber has a substantially circular cross section as viewed in an output rotary shaft direction of the speed reducer.

3. The drive unit according to claim 1,
wherein the upper space and the lower space are at least partially overlapped with the motor chamber and the accommodating chamber, as viewed in a direction of a virtual straight line orthogonal to the output rotary shaft of the drive motor and the output rotary shaft of the speed reducer.

4. The drive unit according to claim 1,
wherein as viewed in a direction of a virtual straight line orthogonal to the output rotary shaft of the drive motor and the output rotary shaft of the speed reducer, the upper space and the lower space have half or more of a projection area, viewed in the direction of the virtual straight line, overlapping with the motor chamber and the accommodating chamber.

5. The drive unit according to claim 1,
wherein the upper space and the lower space store a lubrication fluid for lubricating the speed reducer.

6. The drive unit according to claim 5,
wherein the upper space and the lower space do not allow a motor cooling fluid for cooling the drive motor to flow in.

7. The drive unit according to claim 1,
wherein the upper space and the lower space are integrally formed by casting in the drive unit case.

8. The drive unit according to claim 5,
wherein the upper space and the lower space extend in an axial direction of the output rotary shaft of the speed reducer.

9. The drive unit according to claim 8,
wherein the upper space and the lower space are divided into a plurality of spaces in the axial direction of the output rotary shaft of the speed reducer.

10. The drive unit according to claim 1,
wherein the speed reducer includes a planetary gear mechanism.

11. The drive unit according to claim 10,
wherein the speed reducer includes a differential gear mechanism, and
an input rotary shaft of the planetary gear mechanism and an output rotary shaft of the differential gear mechanism are coaxial.

12. The drive unit according to claim 11,
wherein the planetary gear mechanism includes a sun gear, a plurality of planetary gears, a planetary carrier, and a ring gear,
power input to the planetary gear mechanism is output from the planetary carrier, and
the planetary carrier and a differential case of the differential gear mechanism are integrally formed.
